(19) United States
(12) Patent Application Publication
(10) Pub. No.: US 2008/0008343 A1
(43) Pub. Date: Jan. 10, 2008

(54) Hearing aid with electrophoretic hearing aid case and method for electrophoretic reproduction

(75) Inventor: Kunibert Husung, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/825,070

(22) Filed: Jul. 3, 2007

(30) Foreign Application Priority Data
Jul. 4, 2006 (DE) 10 2006 030 864.6

(51) Int. Cl. H04R 25/00

(52) U.S. Cl. 381/322; 381/324

(57) ABSTRACT

Hearing aid with electrophoretic hearing aid case and method for electrophoretic reproduction The invention relates to a hearing aid, a programming system with a hearing aid and a method. The hearing aid has a hearing aid case with a hearing aid case surface which has an electrophoretic reproduction unit at least in part. The hearing aid is designed to transmit a serial number data record representing a serial number to the electrophoretic reproduction unit for visible reproduction. The invention also relates to a hearing aid with a hearing aid case surface which at least in part has an electrophoretic reproduction unit and which is designed to reproduce at least two distinct color tones. The hearing aid is designed to transmit a color sample data record representing at least one color tone and/or one color sample to the electrophoretic reproduction unit for visible reproduction. The invention also relates to a programming system with a hearing aid and a programming device which is designed to transmit the at least one color sample data record via an interface to the hearing aid. The invention also relates to a method for coloring a hearing aid case, comprising the step of electrophoretic reproduction of a hearing aid case color.

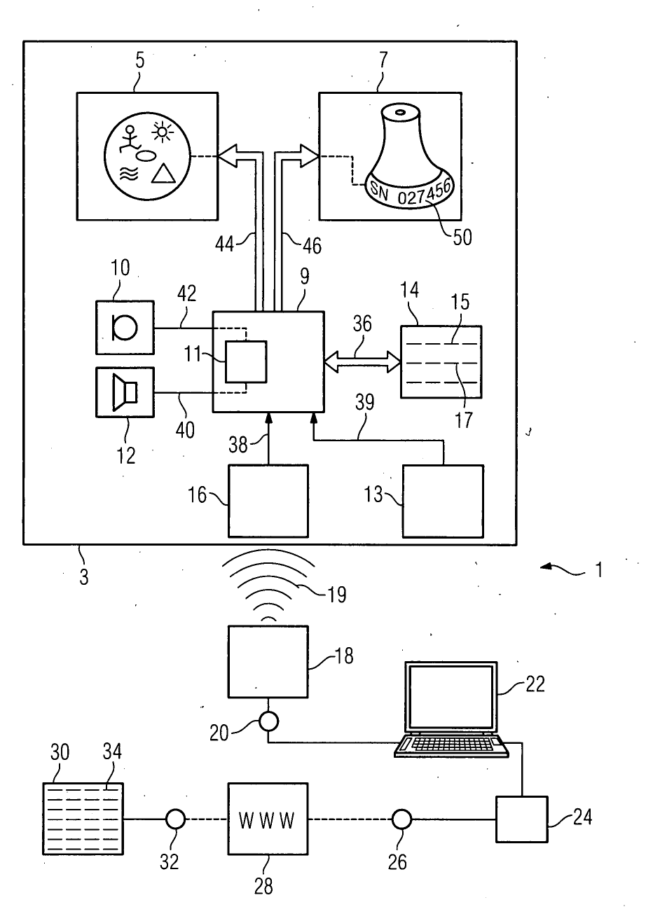

### CROSS REFERENCE TO RELATED APPLICATIONS

This application claims priority of German application No. 10 2006 030 864.6 filed Jul. 04, 2006, which is incorporated by reference herein in its entirety.

### FIELD OF THE INVENTION

The invention relates to a hearing aid with a hearing aid case.

### BACKGROUND OF THE INVENTION

A hearing aid with an electrophoretic display is known from DE 10 2004 023 047 B3. The hearing aid known from DE 10 2004 023 047 B3 is designed to reproduce status information on the electrophoretic display, for example a configure state of the hearing aid, the battery charging status, a selected program and/or a loudspeaker setting. In this way, important status information for third parties, for example a hearing aid acoustician, can be legibly reproduced on the hearing aid.

Such status information is usually reproduced in hearing aids with the aid of an LCD display (LCD=Liquid Crystal Display).

Other information, for example a hearing aid type or serial number, is usually printed on a hearing aid case. Hearing aid cases known from the prior art have a serial number or type information printed on the hearing aid case with a font color that permits a legible contrast to a hearing aid case color. Usual case colors for hearing aids are skin tones so that a hearing aid cannot be so easily identified as such by third parties.

### SUMMARY OF THE INVENTION

The invention is based on the problem that individual production of hearing aid cases and inclusion of type information and a serial number results in costs.

The problem is solved by means of a hearing aid of the type mentioned in the introduction, in which the hearing aid case has a hearing aid case surface. The hearing aid case surface has an electrophoretic reproduction unit at least in part.

The hearing aid is designed in such a way as to transmit a serial number data record representing a serial number to the electrophoretic reproduction unit for visible reproduction of the serial number data record.

Alternatively or in addition to a serial number data record, the hearing aid can be designed in such a way as to transmit a type data record representing type information to the electrophoretic reproduction unit for visible reproduction of the type data record.

By reproducing a serial number or type information by means of an electrophoretic reproduction unit, advantageously electrical energy is only consumed when transmitting the serial number data record. While reproducing a serial number data record, the electrophoretic reproduction unit advantageously does not consume any, or only a little, electrical energy.

Of further advantage, a memory is already provided for a serial number by an electrophoretic reproduction unit.

The hearing aid preferably has a memory linked to the electrophoretic reproduction unit that is designed to save a serial number data record representing a serial number, and/or a type data record. The hearing aid is designed to read out the serial number data record and/or the type data record for reproduction on the electrophoretic reproduction unit from the memory.

A memory for a serial number data record and/or a type data record advantageously includes additional data integrity if an electrophoretic reproduction unit is damaged for example. When an expert replaces a damaged electrophoretic reproduction unit, serial number information is still safeguarded on account of a memory and thus cannot be lost.

Advantageously the hearing aid can be designed to transmit electric refresh impulses to the electrophoretic reproduction unit to store the serial number data record.

The invention also relates to a hearing aid with a hearing aid case. The hearing aid case has a hearing aid case surface, wherein the hearing aid case surface has an electrophoretic reproduction unit at least in part. The electrophoretic reproduction unit is designed to reproduce at least two distinct color tones, in particular as a result of absorption of electromagnetic radiation. The hearing aid is designed in such a way as to transmit a color sample data record representing at least one color tone and/or a color sample to the electrophoretic reproduction unit for visible reproduction.

A color tone reproduced by an electrophoretic reproduction unit can be generated by the electrophoretic reproduction unit at least partially absorbing electromagnetic radiation incident on the electrophoretic reproduction unit with a wavelength spectrum perceptible to the human eye, in particular in the wavelength range from 380 nm to 780 nm and reflecting a proportion of the radiation not absorbed. The reflected electromagnetic radiation may correspond to a color tone perceptible to the human eye on account of the wavelength composition generated by the electrophoretic reproduction unit.

A color sample data record may, for example, have a geometric pattern that can be displayed in two dimensions with distinct colors and/or geometries. In another exemplary embodiment, a color sample data record may represent a predefined color tone perceptible to the human eye regardless of geometry. In this way, a predefined color tone can be assigned to part of a hearing aid case surface.

The aforementioned hearing aid with a variable case color is advantageous in that a user can individually change the appearance of such a hearing aid. Thus, for example, a user of the aforementioned hearing aid can individually match a color or a color sample of the hearing aid case surface to his hair and/or skin color. Such a hearing aid with a variable case color can for example, also be used as jewelry, with a color sample data record representing a predefined jewelry color sample.

In a preferred embodiment, the electrophoretic reproduction unit forms at least a part of the hearing aid case surface that faces outwards for the envisaged use of the hearing aid. As a result, the part of the hearing aid case surface facing outwards is visible to third parties, in particular if it is not covered by hair or objects.

In this embodiment a hearing aid case surface which represents a color sample data record can be advantageously perceived by third parties.

In an advantageous embodiment, the hearing aid has an interface to receive a serial number data record and/or a color sample data record.

Such an interface may be a cord-linked interface with a connector provided for this purpose, for example a serial interface.

In another embodiment, the interface is advantageously designed for cordless receipt of the serial number data record or color sample data record. Exemplary embodiments for a cordless transmission interface are an infrared interface, in particular an infrared interface as per the IrDA standard (IrDA=Infrared Data Association) or a Bluetooth interface.

An interface for cordless transmission of a color sample data record or a serial number data record may be designed for electromagnetic transmission, in particular for electromagnetic transmission of deep frequencies or for electromagnetic transmission in a radio frequency range.

An interface for the cordless transmission of deep frequencies may, for example, comprise a hearing aid telecoil and transmit a color sample data record and/or a serial number data record unmodulated at a frequency range of between 300 and 10,000 Hz.

An interface to transmit a color sample data record and/or a serial number data record in the radio frequency range can operate in a carrier frequency range of between 100 and 200 kHz and using one of the following modulation methods, or with a combination of the following modulation methods:
FM (FM=Frequency Modulation)
AM (AM=Amplitude Modulation)
FSK (FSK=Frequency Shift Keying)
ASK (ASK=Amplitude Shift Keying)
PSK (PSK=Phase Shift Keying)

In a preferred embodiment, the hearing aid has a color sample memory which is designed to store at least one color sample data record representing a color sample.

The color sample memory is in particular linked to the electrophoretic reproduction unit.

For example, the hearing aid may be designed to read out a color sample data record from the color sample memory in dependence on a user interaction signal and to transmit this to the electrophoretic reproduction unit.

By keeping color sample data records available, selecting a predefined color sample data record and transmitting the selected color sample data record to the electrophoretic reproduction unit, a user can advantageously change a case color and/or a case color sample of the hearing aid.

The invention also relates to a programming system with a hearing aid of the aforementioned type. The programming system has a programming device, the programming device having a color sample memory for at least one color sample data record and an interface to transmit at least one color sample data record. The programming device is designed to transmit at least one color sample data record via the interface to the hearing aid.

In this way, a hearing aid user can advantageously select a color sample data record kept available in the programming device with the aid of the programming device and transmit this to the hearing aid to change the hearing aid case color.

The user can, for example, put the programming device in an area with coverage from an interface of the hearing aid and for example, generate a user interaction signal by pressing a button on the programming device, whereupon the programming device can transmit the selected color sample data record to the hearing aid in dependence on the generated user interaction signal.

The hearing aid may, for example, be worn in a user's ear during the aforementioned transmission procedure, with the user being able to hold the programming device in one hand in front of the ear wearing the hearing aid and thus enabling the programming device to have coverage from the hearing aid.

The invention also relates to a programming system which has a central server for many color sample data records and the programming device has an interface which is designed to set up a connection with the server and to transmit at least one of the many color sample data records from the server to the programming device.

For example, such a color sample data record server can be linked to the Internet. The programming device can be designed for connection to the Internet and to link up with the server. The programming device can then, for example, transmit at least one color sample data record via the Internet from the server to a color sample memory of the programming device.

In an advantageous embodiment, the programming device is at least partially composed of a personal computer. For example, a programming device in this embodiment can have an interface for connection to a personal computer, for example a serial interface or a USB interface.

A programming system with a personal computer can also have a personal computer, a control program for the personal computer to control the programming device, and the programming device.

In another advantageous embodiment the programming device is a cell phone.

The cell phone can, for example, have an interface provided for connection to a hearing aid.

The cell phone can, for example, transmit at least one color sample data record from a central server to the cell phone via a GPRS interface (GPRS=General Packet Radio Service) or a UMTS interface (UMTS=Universal Mobile Telecommunications System).

An electrophoretic reproduction unit can have bipolar, monochrome or two-color particles which, for example, can be suspended in an inert liquid. The inert liquid can be included in a capsule together with the bipolar particles. The inert liquid itself can be colored and absorb electromagnetic radiation in the visible range for this purpose. The electrophoretic reproduction unit can generate a correspondingly arranged electrical field to align the bipolar particles by means of the electrical field generated. A bipolar particle can be fluorescent and/or reflecting.

A suspension to hold a bipolar particle can display liquid crystal behavior. The liquid crystal suspension can, for example, block or enable electrophoretic migration of the bipolar particles in dependence on an applied electrical field.

An electrophoretic reproduction unit may have several layers, with suspensions with distinct bipolar particles being kept available between the layers.

A preferred embodiment of an electrophoretic reproduction unit has a rheologically controllable suspension, the rheologically controllable suspensions each having electrophoretically mobile bipolar particles to generate a color property by means of reflection and/or fluorescence. Orientation of the bipolar particles in the suspension remains advantageous in this embodiment even without the proximity of an electrical field.

Preferably the electrophoretic reproduction unit has color particles or color pigments which together can form reference color stimuli for a color space. Examples of reference color stimuli for color particles are magenta, cyan and yellow.

The electrophoretic reproduction unit can be designed to generate a combination of reference color stimuli by means of at least one electrical field, which together can form a color tone of a rendition surface of an electrophoretic reproduction unit.

A color tone can be created by means of reference color stimuli through additive and/or subtractive color mixture of the reference color stimuli.

In addition or regardless of a reference color stimuli system, an electrophoretic reproduction unit can have black and/or white color particles.

Examples of color particles for black are carbon black particles; examples of color particles for white are titanium dioxide or barium sulfate.

A transparent electrode to generate an electrical field can advantageously have zinc oxide or be formed thereof.

An electrophoretic reproduction unit with one reproductive level can have many individual reproduction units arranged laterally and/or in layers obliquely to the reproduction level and controllable by means of an electrical field, in particular color particles containing microcells.

For example, individual reproduction units controllable by means of an electrical field can together form a matrix to generate a color sample or a font.

An electrophoretic reproduction unit can have layers containing water and/or particularly colored oil. The electrophoretic reproduction unit can generate an electrical field to displace the colored oil through the water and thus in dependence on an electric voltage to color at least one area, in particular a picture element of an electrophoretic reproduction unit.

In this way a hearing aid surface can advantageously be colored more or less intensively in dependence on an electric voltage. A three-layer electrophoretic reproduction unit with colored oil can have three distinct reference color stimuli. Three distinct reference color stimuli can be, for example, magenta, cyan and yellow.

The invention also relates to a method for coloring a hearing aid case, comprising the following step
electrophoretic reproduction of a hearing aid case color.

In an advantageous embodiment a method to change the case color of a hearing aid comprises the following steps:
transmission of a color sample data record representing a color sample to a hearing aid;
at least partial changing of the case color of the electrophoretic case surface of the hearing aid in dependence on the color sample data record.

In an advantageous embodiment a method to reproduce a hearing aid serial number comprises the following steps:
reproduction of a serial number and/or type information by means of an electrophoretic reproduction unit of a hearing aid, in particular, by transmitting a serial number data record representing a serial number, and/or a type data record representing type information to the electrophoretic reproduction unit of a hearing aid.

Additional advantageous embodiments emerge from the features stated in the dependent claims.

All aforementioned embodiments for a hearing aid solve the problem mentioned in the introduction by reproducing static information in an energy-saving manner. Static information is information which is not required to operate the hearing aid and is therefore independent of operational changes to the hearing aid.

### BRIEF DESCRIPTION OF THE DRAWINGS

The invention is explained in detail on the basis of a FIGURE which shows an arrangement of a hearing aid.

### DETAILED DESCRIPTION OF THE INVENTION

The FIGURE shows an arrangement 1 with a hearing aid 3, a programming device 18, a personal computer 22 and a color sample server 30.

The Internet 28 is also shown, which can be used by the personal computer 22 and the server 30 but is not part of the arrangement according to the invention.

The hearing aid 3 has an electrophoretic reproduction unit 5 and an electrophoretic reproduction unit 7.

The electrophoretic reproduction unit 5 forms a part of a hearing aid case surface which is visible on the outside when the hearing aid is worn as intended.

The electrophoretic reproduction unit 7 forms an area of the hearing aid case surface that is not visible on the outside when the hearing aid is worn and is designed to reproduce a serial number data record 50.

The reference character of the serial number data record 50, for example, points to the FIGURE of the serial number SN027456 shown as an example in this FIGURE.

The hearing aid 3 also has a central control unit 9, a sound pick-up 10, a signal generator 12 and a memory 14. The memory 14 is designed to keep a serial number data record 15 and at least one color sample data record 17.

The memory 14 is linked via a bi-directional data bus 36 to the central control unit 9 which is designed to store in the memory 14 or read out from said memory a color sample data record 17 and/or a serial number data record 15 via the bi-directional data bus 36.

The hearing aid 3 also has an interface 16 which for example can be designed as an infrared interface or as an electromagnetic interface, in particular with a telecoil.

The hearing aid 3 also has a transmission unit 11 which in this exemplary embodiment is part of the central control unit. The control unit 9 and the transmission unit 11 are each linked on the input side via a connecting lead 42 to the sound pick-up 10 and on the output side via a connecting lead 40 to the sound generator 12. The sound pick-up 10 is designed to receive sound waves and to generate a microphone signal which represents the received sound waves. The sound generator 12 is designed to generate a sound in dependence on a power signal received on the input side, which sound represents the power signal.

The control unit 9, in particular in this exemplary embodiment the transmission unit 11, is designed, in dependence on a microphone signal received via the connecting lead 42, to generate a power signal in dependence on a predefined allocation instruction, and to transmit the power signal on the output side via the connecting lead 40 to the sound generator 12.

The central control unit 9 is connected via a data bus 44 on the output side to the electrophoretic reproduction unit 5 and via a data bus 46 on the output side to the electrophoretic reproduction unit 7.

The central control unit 9 is connected on the output side via a connecting lead 38 to the interface 16. The central control unit 9 is designed to transmit a serial number data record received via the interface 16 and/or a color sample data record via the bi-directional data bus 36 to the memory 14 and to save there.

The hearing aid 3 also has a user interface 13 which is connected via a connecting lead 39 to the central control unit 9. The user interface 13 is designed to generate a user interaction signal in dependence on a user interaction and to output this on the output side.

For example, the user interface 13 can be designed as a button or as a cordless interface for receipt of a cordlessly transmitted user interaction signal.

The central control unit 9 can, for example, in dependence on a user interaction signal received on the input side via the connecting lead 39 read out a color sample data record 17 via the bi-directional data bus 36 from the memory 14 and transmit this via the data bus 44 to the electrophoretic reproduction unit 5.

The serial number data record 15 can for example be read out from the central control unit 9 via the bi-directional data bus 36 from the memory 14 and be transmitted via the data bus 46 to the electrophoretic reproduction unit 7 for reproduction of the serial number data record by means of the electrophoretic reproduction unit 7.

Arrangement 1 also comprises a programming device 18. The programming device 18 has an interface on the output side for cordless transmission of a color sample data record and/or a serial number data record. A cordlessly transmitted color sample data record 19 is shown as an example.

The programming device 18 has an interface 20 on the input side for connection to a personal computer 22.

The interface 20 is a USB interface (USB=Universal Serial Bus) in this exemplary embodiment. The personal computer 22 has a control program in this exemplary embodiment to control the programming device 18.

The personal computer 22 is linked to a modem 24 in this exemplary embodiment, with the modem 24 being linked to an interface 26 for connection to the Internet 28. The modem 24 can be, for example, a DSL modem (DSL=Data Subscriber Line) or an ISDN modem (Integrated Services Digital Network).

The modem 24 is designed for connection via an interface 26, for example a telephone interface, to the Internet 28.

The color sample server 30 is designed to keep a plurality of color sample data records 34 and can be connected to the Internet 28 via an interface 32.

The connections of the interfaces 26 and 32 to the Internet 28 are shown as dashed lines. This means that the Internet 28 is not part of the arrangement 1, but can be used by it.

The personal computer 22 can now, for example, set up a connection to the color sample server 30 via the modem 24, the interface 26, the Internet 28 and via the interface 32 and select a color sample data record 34 from the color sample server 30 and download this—the reverse of the aforementioned connection. The personal computer 22 can, for example—controlled by a control program—transmit the downloaded color sample data record on the output side via the interface 20 to the programming device 18. The programming device 18 can receive and store the transmitted color sample data record on the input side via the interface 20. In a further step the programming device 18 can, for example—in particular, in dependence on a user interaction signal—cordlessly transmit the color sample data record 19 to the interface 16 of the hearing aid 3.

In a further step the central control unit 9 can receive the color sample data record signal via the connecting lead 38.

The central control unit 9 can in a further step transmit the cordlessly transmitted color sample data record 19 directly via the data bus 44 to the electrophoretic reproduction unit 5—or save this via the bi-directional data bus 36 in the memory 14 as a color sample data record 17.

Independently of the interface 16 of the hearing aid 3 for cordless connection to the programming device 18 shown in this exemplary embodiment, an interface 16 can be linked by a cord to the programming device 18.

Such a cord connection can, for example, comprise an electrically conductive connecting lead or an optical waveguide for electromagnetic waves.

1-14. (canceled)

15. A hearing aid with a hearing aid case, comprising:
an electrophoretic reproduction unit arranged in the hearing aid case that reproduces a data record of the hearing aid,
wherein the hearing aid is configured to transmit the data record to the electrophoretic reproduction unit for the reproduction of the data record.

16. The hearing aid as claimed in claim 15, wherein the reproduction is a visible reproduction.

17. The hearing aid as claimed in claim 15, further comprising an interface for receiving the data record.

18. The hearing aid as claimed in claim 17, wherein the interface is a cordless interface.

19. The hearing aid as claimed in claim 15, further comprising a memory operatively connected to the electrophoretic reproduction unit for storing the data record.

20. The hearing aid as claimed in claim 19, wherein the hearing aid reads out the data record from the memory for the reproduction.

21. The hearing aid as claimed in claim 15, wherein the data record is selected from the group consisting of: a serial number data record, a type data record, and a color sample data record.

22. The hearing aid as claimed in claim 15, wherein the electrophoretic reproduction unit forms a part of a surface of the hearing aid case facing outwards in an envisaged use of the hearing aid.

23. A programming system for a hearing aid, comprising:
a programming device that transmits a data record to the hearing aid via an interface; and
a memory that stores the data record.

24. The programming system as claimed in claim 23, wherein the hearing aid reads out the data record from the memory for reproducing the data record.

25. The programming system as claimed in claim 23, wherein the data record is selected from the group consisting of: a serial number data record, a type data record, and a color sample data record.

26. The programming system as claimed in claim 25, wherein the color sample data record is selected from a plurality of color sample data records stored in a central server.

27. The programming system as claimed in claim 26, wherein the central server is connected to the programming device.

28. The programming system as claimed in claim 23, wherein the programming device is a personal computer.

29. The programming system as claimed in claim 23, wherein the programming device is a cell phone.

30. A method for reproducing a data record of a hearing aid, comprising:
transmitting the data record to the hearing aid; and
electrophoreticly reproducing the data record based on the transmitted data record.

31. The method as claimed in claim 30, wherein the data record is selected from the group consisting of: a serial number data record, a type data record, and a color sample data record.

32. The method as claimed in claim 31, wherein a color of a case of the hearing aid is reproduced or changed based on the color sample data record.

33. The method as claimed in claim 30, wherein the data record is electrophoreticly reproduced by an electrophoretic reproduction unit of the hearing aid.
